(19) United States
(12) Patent Application Publication
(10) Pub. No.: US 2010/0053666 A1
(43) Pub. Date: Mar. 4, 2010

(54) IMAGE COMMUNICATION APPARATUS AND COMPUTER READABLE MEDIUM

(75) Inventor: Satoshi KAMIYA, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO.,LTD., Tokyo (JP)

(21) Appl. No.: 12/367,748

(22) Filed: Feb. 9, 2009

(30) Foreign Application Priority Data
Aug. 28, 2008 (JP) 2008-218977

(51) Int. Cl. G06F 3/12

(52) U.S. Cl. 358/1.15

(57) ABSTRACT

An image communication apparatus includes: a first receiving unit that receives image data through a first communication method; a second receiving unit that receives image data through one kind or two or more kinds of second communication methods; a determining unit, when the image communication apparatus receives a call for receiving image data through the first communication method and the first communication unit cannot receive the image data since the first communication unit is used to receive other image data, determines one communication method out of the second communication methods according to a standard; and an informing unit that informs a caller about the determined second communication method and information indicating that the first communication unit cannot receive the image data specified by the call.

### CROSS-REFERENCE TO RELATED APPLICATIONS

This application is based on and claims priority under 35 USC 119 from Japanese Patent Application No. 2008-218977 filed Aug. 28, 2008.

### BACKGROUND

1. Technical Field

The present invention relates to an image communication apparatus and a computer readable medium.

2. Related Art

When a certain facsimile apparatus is transmitting and receiving a large amount of faxes, it takes a long time to complete such large fax transmission and reception. In this case, even when a second person tries to send a fax to this facsimile apparatus, due to a timer function, after the fax is tried several times for transmission, there is output an un-transmitted report on the fax. Therefore, even if the second person thinks that the fax has been sent, in fact, there is a possibility that the fax has not arrived at a person to whom the fax was sent.

However, when a fax apparatus on the receiving side has two or more kinds of receiving method for receiving image unit, for example, when the fax apparatus is capable of using both an IP fax and an analog fax, even if one kind of receiving unit for receiving image data is busy, other kind of receiving unit can be used to receive image data, that is, this free receiving unit can be used as the alternative unit for the busy image data receiving unit. In this case, when the fax apparatus is controlled in such a manner that the alternative image data receiving unit is allowed to receive the image data, a transmitting side can send an image immediately even when one of the image data receiving unit is busy, and thus a receiving side also can receive this image immediately.

### SUMMARY

According to an aspect of the invention, an image communication apparatus includes: a first receiving unit that receives image data through a first communication method; a second receiving unit that receives image data through one kind or two or more kinds of second communication methods; a determining unit, when the image communication apparatus receives a call for receiving image data through the first communication method and the first communication unit cannot receive the image data since the first communication unit is used to receive other image data, determines one communication method out of the second communication methods according to a standard; and an informing unit that informs a caller about the determined second communication method and information indicating that the first communication unit cannot receive the image data specified by the call.

### BRIEF DESCRIPTION OF THE DRAWINGS

Exemplary embodiment(s) of the present invention will be described in detail based on the following figures, wherein:

FIG. 1 is an explanatory view of a system structure when an image processing apparatus serving as the exemplary embodiment 1 according to the invention is introduced into an office or the like;

FIG. 2 is a block diagram of the electric connection of the image processing apparatus serving as the exemplary embodiment 1 according to the invention;

FIG. 3 is a flow chart of a processing to be executed by the image processing apparatus serving as the exemplary embodiment 1 according to the invention;

FIG. 4 is a flow chart of a processing to be executed by the image processing apparatus serving as the exemplary embodiment 1 according to the invention;

FIG. 5 is an explanatory view of a format of a packet to be sent in an informing response which is made in order to inform not only that the line of the IP fax is busy but also which one of the communication unit has been selected;

FIG. 6 is a flow chart of a processing to be executed by the image processing apparatus serving as the exemplary embodiment 2 according to the invention; and

FIG. 7 is a flow chart of a processing to be executed by the image processing apparatus serving as the exemplary embodiment 2 according to the invention.

### DETAILED DESCRIPTION

Now, description will be given below of several examples of exemplary embodiments according to the invention.

### Exemplary Embodiment 1

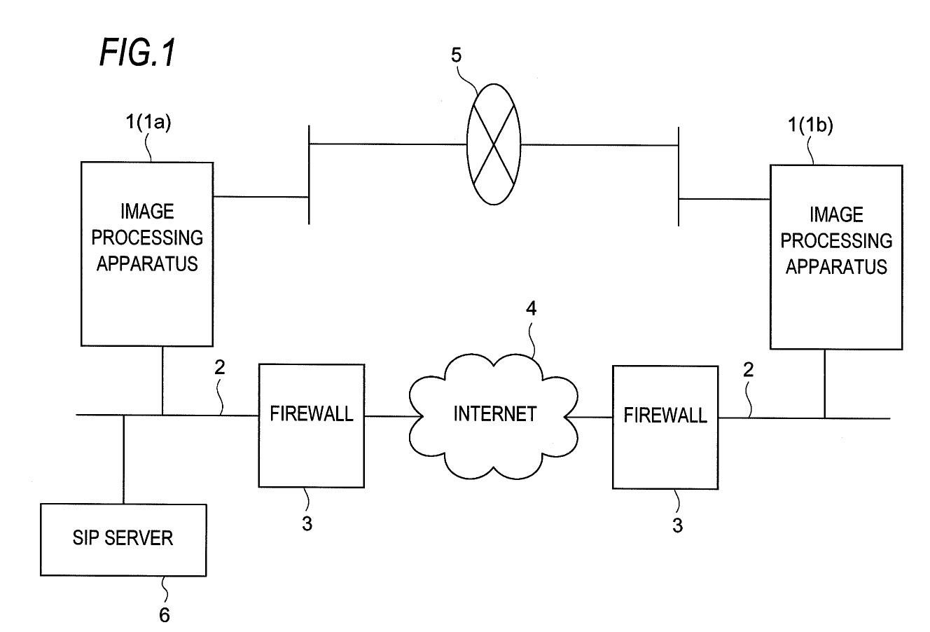

FIG. 1 is an explanatory view of a system structure when an image processing apparatus serving as a first exemplary embodiment of the invention is introduced into an office or the like.

An image processing apparatus 1 has a composite function including a copying function, a printing function, a scanning function, a fax transmitting and receiving function and other similar functions; and thus, the image processing apparatus 1 can transmit and receive image data using an IP fax or the like through a LAN 2, a fire wall 3 and an internet 4.

Also, the image processing apparatus 1 can transmit and receive image data using an analog data fax through a public line network.

A SIP (Session Initiation Protocol) server 6 connected to the LAN 2, when transmitting an IP fax, converts a phone number to an IP address and requests a receiving side apparatus of connection.

In the following example, description will be given in the following manner that an image processing apparatus 1a serves as a transmitting side apparatus and an image processing apparatus 1b serves a receiving side apparatus.

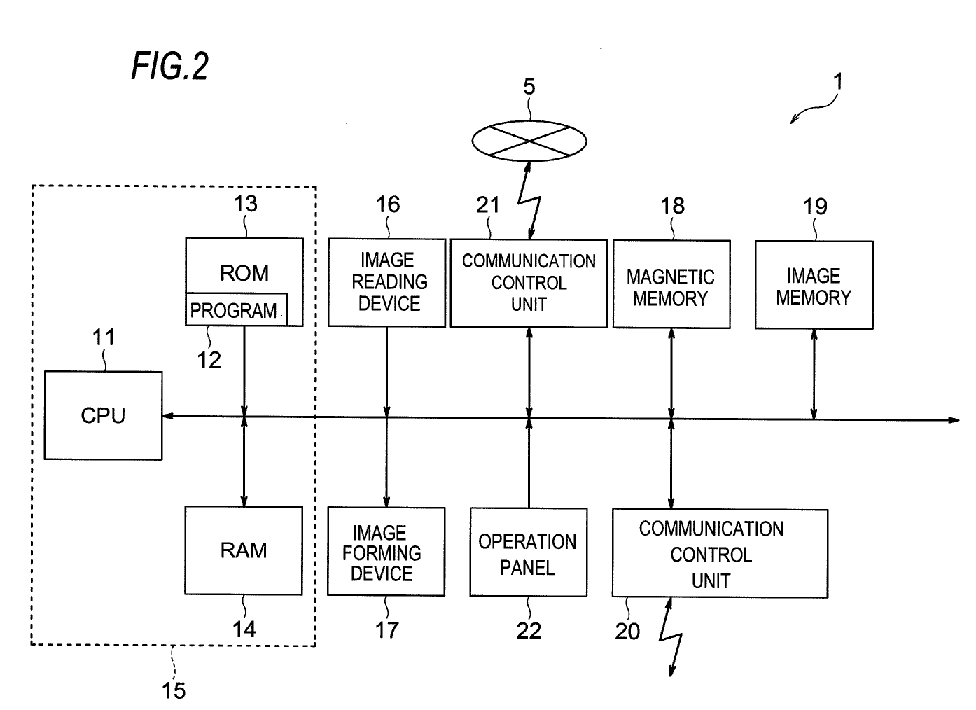

FIG. 2 is a block diagram of the electric connection of the image processing apparatus.

The image processing apparatus 1 comprises a system control portion 15. In the system control portion 15, there are connected together a CPU 11 for controlling the respective portions of the system control portion 15 collectively, a ROM 13 storing therein a control program 12 for operating the CPU 11 and fixed data, and a RAM 14 serving as the operation area of the CPU 11.

To the system control portion 15, there are connected the following elements: that is, an image reading device 16 for reading the image of a document; an image forming apparatus 17 for forming an image on a medium such as paper according to image data; a magnetic memory 18 for storing various kinds of data; an image memory 19 for storing the image data; a communication control unit 20 for communicating with the LAN 2 and internet 4; a communication control unit 21 for communicating with the public line network 5; and, an operation panel 22.

The control program 12 may be stored in the ROM 13 originally. Or, the control program 12 may also be transmitted through the internet 4 to the image processing apparatus 1 in the form of carriers, and the thus transmitted control program 12 may be then set up in the magnetic memory 18 or the like. Or, the control program 12 may also be provided in a state where it is stored in a recording medium such as a CD, a DVD and an MO, the control program 12 may be read by a read device capable of reading these recording mediums, and the thus read control program 12 may be then set up in the magnetic memory 18 or the like.

The image processing apparatus 1 includes the following four kinds of method respectively serving as communication method for transferring the image data read by the image reading device 16 to other facsimile apparatus or the like through the LAN 2, internet 4 or public line network 5.

(1) IP Fax Transmission Method

This is a communication method which transfers an IP fax to a fax apparatus on the receiving side or the like through the SIP server 6 using the LAN 2 and internet 4.

(2) G3/G4 Fax Transmission Method

This is a communication method which transfers an image to the fax apparatus on the receiving side or the like through the public line network 5 using an analog fax.

(3) Direct Transfer Method

This is a communication method which, using Scan to FTP (File Transfer Protocol), Scan to SMB (Sever Message Block), Scan to HTTP (Hyper Text Transfer Protocol) or Scan to SIP (Session Initiation Protocol), transfers image data through the LAN 2 and internet 4.

(4) Scan to E-Mail

This is a communication method which transfers image data attached to E-mail through a mail server (not shown) using the LAN 2 and internet 4.

Next, description will be given below of an image data transmitting and receiving processing to be executed by the image processing apparatus 1 while the image processing apparatus 1a serves as an apparatus on the transmitting side and the image processing apparatus 1b serves as an apparatus on the receiving side.

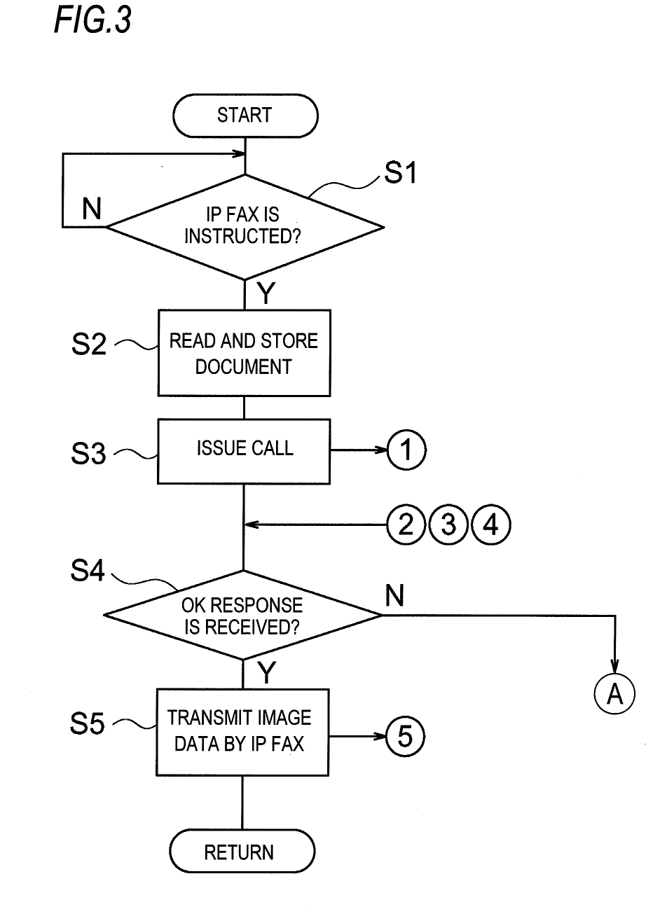

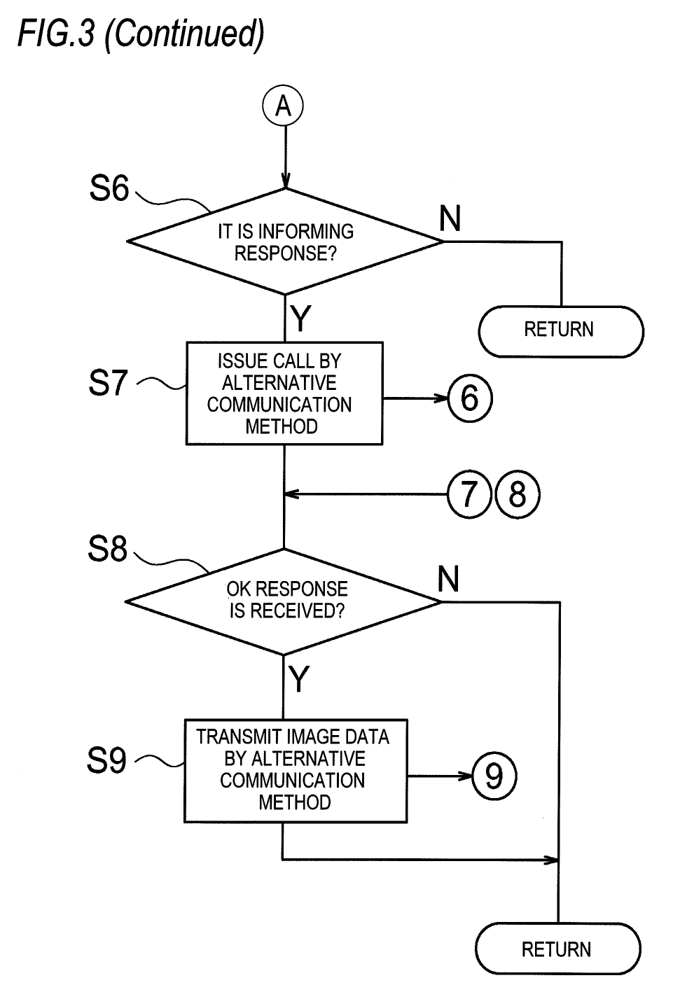

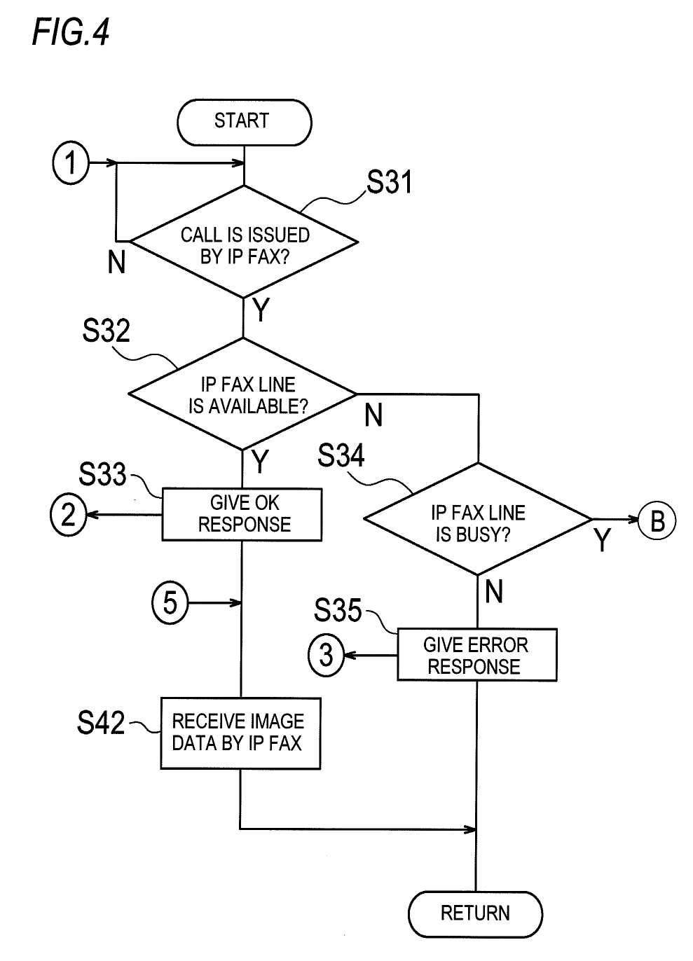

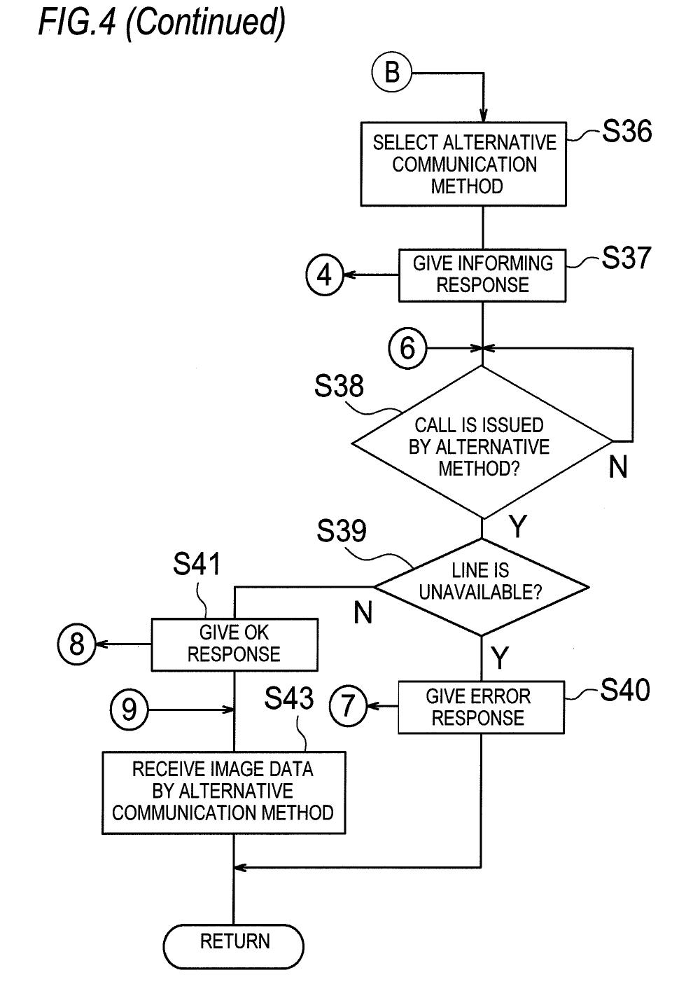

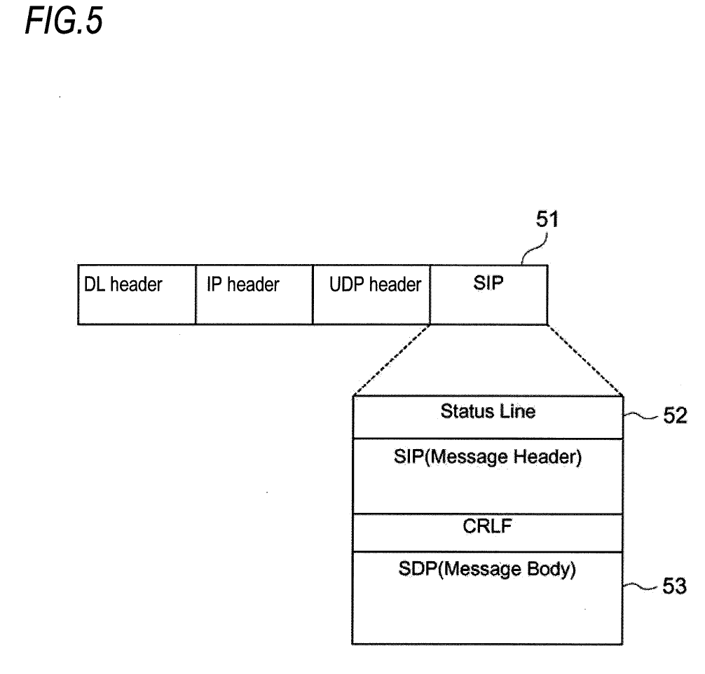

FIG. 3 is a flow chart to explain the processing to be executed by the image processing apparatus 1a, whereas FIG. 4 is a flow chart to explain the processing to be executed by the image processing apparatus 1b.

The image processing apparatus 1, normally, carries out an operation to transmit and receive an IP fax. Specifically, when a user wanting to transmit an IP fax sets a document on the image processing apparatus 1a, specifies a receiving side and operates the operation panel 22 to thereby instruct the execution of the IP fax transmission (in Step S1, Y), the system control portion 15 (specifically, the CPU 11) of the image processing apparatus 1a reads the image of the document using the image reading device 16, stores the image into the image memory 19 (Step S2), and issues a call to a fax receiving side (Step S3).

Thus, when the receiving-side image processing apparatus 1b receives the call (in Step S31, Y), it is checked whether the line of the IP fax is available or not (Step S32). When the line of the IP fax is available (in Step S32, Y), the apparatus 1b sends an OK response to the image processing apparatus 1a (Step S33). When the line of the IP fax is busy (in Step S34, Y), the processing goes to Step S36; and, when the line of the IP fax is unavailable for other reasons (in Step S34, N), an error response is sent to the image processing apparatus 1a (Step S35), ending the processing.

When the line of the IP fax is busy (in Step S34, Y), there is selected the communication method (alternative communication method) that can be substituted for the IP fax line and is best suitable for reception of the image data (Step S36).

This selection is carried out from the above-mentioned communication method (2) to (4) according to a predetermined standard.

Firstly, when the image processing apparatus 1b is present within the inside of the same office with respect to the image processing apparatus 1a (the inside and outside of the office are decided by checking whether they are present in the range of the LAN 2 or not and they are connected together through the internet 4 or not), (3) direct transfer or (4) Scan to E-mail is selected; and, when the image processing apparatus 1b is present in the outside of the same office with respect to the image processing apparatus 1a, (2) G3/G4 fax transmission is selected.

Also, there is a case where an image is to be received by a fax even when the transmitting and receiving image processing apparatuses are both present in the inside of the same office. In this case, instead of (3) direct transfer and (4) Scan to E-mail, (2) G3/G4 fax transmission is selected. On the other hand, when importance is attached to the quickness of the image transmission or to the quality of the image transmitted, for the inside of the same office, there is selected (3) direct transfer or (4) Scan to E-mail. The selection of the method in the inside of the same office should be determined according to the setting of the inside of the image processing apparatus 1b.

When the alternative communication method is selected (Step S36), there is made a response informing that the line of the IP fax is busy and also which one of the communication method has been selected (Step S37).

When the image processing apparatus 1a receives an OK response from the image processing apparatus 1b (in Step S4, Y), it transmits the image data through the IP fax (Step S5). When the image processing apparatus 1a receives such informing response (in Step S6, Y), it calls out the image processing apparatus 1b using the alternative communication method informed (Step S7). When the image processing apparatus 1a receives an error response (in Step S6, N), it ends the processing.

Suppose the image processing apparatus 1b is called out by the communication method selected as the alternative communication method (in Step S38, Y), when the line of the selected alternative communication method cannot be used because it is busy or for some other reasons (in Step S39, N), the image processing apparatus 1b sends an error response to the image processing apparatus 1a (Step S40), ending the processing. When the line of the selected alternative communication method is available (in Step S39, Y), the image processing apparatus 1b sends an OK response to the image processing apparatus 1a (Step S41). Also, the image processing apparatus 1b receives through the IP fax the image data transmitted in Step S5 (Step S42).

When the image processing apparatus 1a receives an OK response (in Step S8, Y), it transmits the image data through the selected alternative communication method (Step S9). And, the image processing apparatus 1b receives this image data (Step S43).

FIG. 5 is an explanatory view of an example of a format of a packet to be transmitted as a response to be informed in Step S37 when the response tells that the line of the IP fax is busy and also the selected one of the communication method.

This packet contains SIP 51. The Status-line 52 portion of the SIP 51 contains information which informs that the line of the IP fax is busy; and also, the SDP (Message Body) 53 portion of the SIP 51 contains information telling which one of the communication methods has been selected.

As described above, according to the image processing apparatus 1, even when the IP fax is busy, the receiving side itself selects, from other communication methods, the optimum communication method capable of receiving the image data according to the predetermined standard and can receive the image data using the selected communication method, thereby being able to realize early image data transmission and positive image data reception.

### Exemplary Embodiment 2

In the present exemplary embodiment as well, the hardware structure described above with reference to FIGS. 1 and 2 as well as the data structure described above with reference to FIG. 5 are employed similarly to the previously described exemplary embodiment 1 and thus, the detailed description thereof is omitted here.

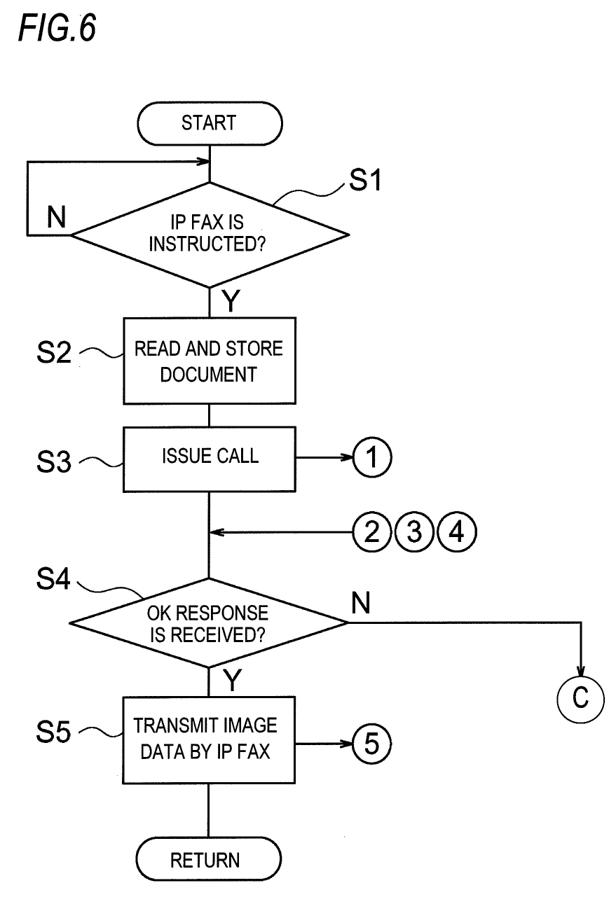

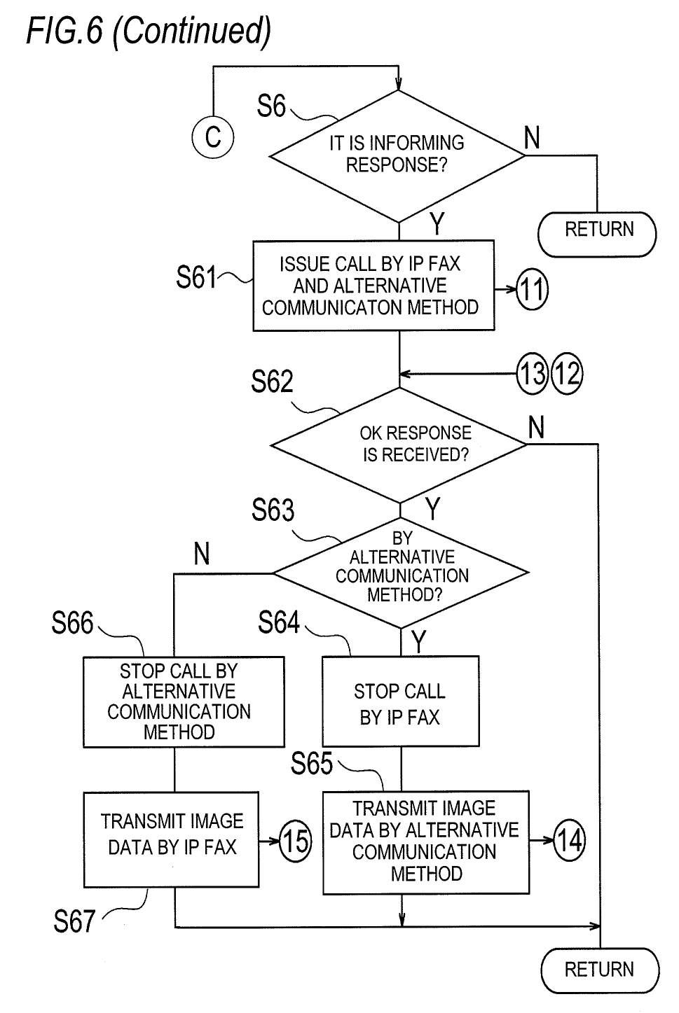

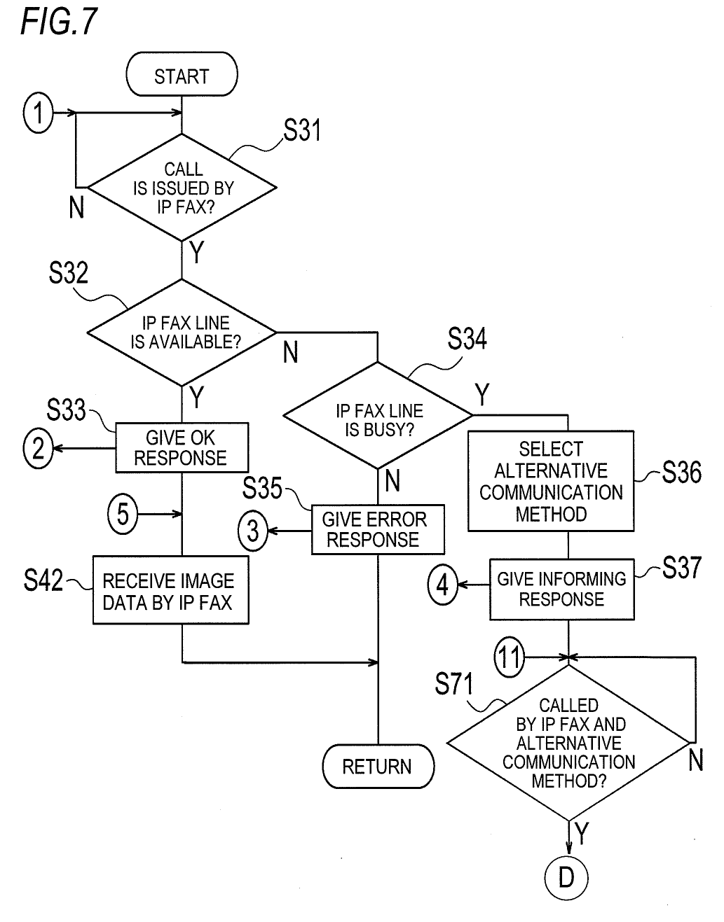

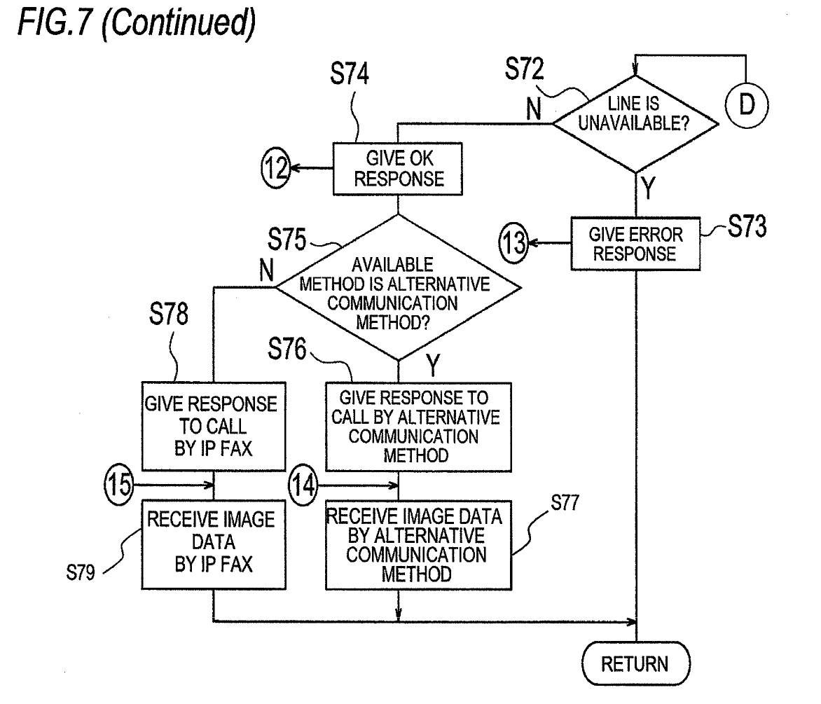

The present exemplary embodiment is different from the exemplary embodiment 1 in that it carries out processings shown in FIGS. 6 and 7 instead of the processings shown in FIGS. 3 and 4. Specifically, FIG. 6 is a flow chart which is used to explain the processing to be executed by the image processing apparatus 1a, while FIG. 7 is a flow chart to explain the processing to be executed by the image processing apparatus 1b.

The image processing apparatus 1, normally, carries out an operation to transmit and receive an IP fax. Specifically, when a user wanting to transmit an IP fax sets a document on the image processing apparatus 1a, specifies a receiving side and operates the operation panel 22 to thereby instruct the execution of the IP fax transmission (in Step S1, Y), the system control portion 15 (specifically, the CPU 11) of the image processing apparatus 1a reads the image of the document using the image reading device 16, stores the image into the image memory 19 (Step S2), and issues a call to a fax receiving apparatus (Step S3).

Thus, when the receiving-side image processing apparatus 1b is called out (in Step S31, Y), it is checked whether the line of the IP fax is available or not (Step S32). When the line of the IP fax is available (in Step S32, Y), an OK response is made to the image processing apparatus 1a (Step S33). When the line of the IP fax is busy (in Step S34, Y), the processing goes to Step S36; and, when the line of the IP fax is unavailable for some other reasons (in Step S34, N), an error response is given to the image processing apparatus 1a (Step S35), ending the processing.

When the line of the IP fax is busy (in Step S34, Y), there is selected the communication method (alternative communication method) that can be substituted for the IP fax line and is best suitable for reception of the image data (Step S36).

This selection is carried out from the above-mentioned communication methods (2) to (4) according to a predetermined standard.

Firstly, when the image processing apparatus 1b is present in the inside of the same office with respect to the image processing apparatus 1a (the inside and outside of the office are decided by checking whether they are present in the range of the LAN 2 or not and they are connected together through the internet 4 or not), (3) direct transfer or (4) Scan to E-mail is selected; and, when the image processing apparatus 1b is present in the outside of the same office with respect to the image processing apparatus 1a, (2) G3/G4 fax transmission is selected.

Also, there is a case where an image is to be received by a fax even when the transmitting and receiving image processing apparatus are both present in the inside of the same office. In this case, instead of (3) direct transfer and (4) Scan to E-mail, (2) G3/G4 fax transmission is selected. On the other hand, when importance is attached to the quickness of the image transmission or to the quality of the image transmitted, for the inside of the same office, there is selected (3) direct transfer or (4) Scan to E-mail. The selection of the method in the inside of the same office should be determined according to the setting of the inside of the image processing apparatus 1b.

When the alternative communication method is selected (Step S36), there is given a response informing that the line of the IP fax is busy and also which one of the communication method has been selected (Step S37).

In this manner, when the image processing apparatus 1a receives an OK response from the image processing apparatus 1b (in Step S4, Y), it transmits the image data through the IP fax (Step S5) and the image processing apparatus 1b receives this image data (Step S42). When the image processing apparatus 1a receives such informing response (in Step S6, Y), it issues a call to the image processing apparatus 1b using the alternative communication method informed and IP fax (Step S61). When the image processing apparatus 1a receives an error response (in Step S6, N), it ends the processing.

After the image processing apparatus 1b is called out through both the selected alternative communication method and IP fax (in Step S71, Y), when the line of the selected alternative communication method and the line of the IP fax cannot be used because they are busy or for some other reasons (in Step S72, N), the image processing apparatus 1b gives an error response to the image processing apparatus 1a (Step S73), thereby ending the processing. When the line of the selected alternative communication method or IP fax is available (in Step S72, Y), the image processing apparatus 1b gives an OK response to the image processing apparatus 1a (Step S74).

When the image processing apparatus 1a receives an error response (in Step S62, N), it ends the processing. When it receives an OK response (in Step S62, Y) and such response is given through the alternative communication method (in Step S63, Y), the image processing apparatus 1a stops the issue of the call to the IP fax (Step S64) and transmits the image data through the alternative communication method (Step S65).

When such response is given through the IP fax (in Step S63, N), the image processing apparatus 1a stops the issue of the call to the alternative communication method (Step S66), and transmits the image data through the IP fax (Step S67).

When the available method is the alternative communication method (in Step S75, Y), the image processing apparatus 1b gives a response to the call through the alternative communication method (Step S76), and thus receives the image data through the alternative communication method (Step S77).

When the available method is the IP fax (in Step S75, N), the image processing apparatus 1b gives a response to the call through the IP fax (Step S78), and thus receives the image data through the IP fax (Step S79).

As described above, according to the image processing apparatus 1, even when the IP fax is busy, the receiving side apparatus itself can select, from several kinds of communication methods capable of receiving the image data, one proper communication method (alternative communication method) according to the predetermined standard, and can receive the image data through one of the thus selected alternative communication method and IP fax that is ready to communicate earlier than the other. Thus, when compared with a structure such as the structure of the exemplary embodiment 1 in which communication can be attained only through the alternative communication method, it is possible to enhance a possibility that the communication line between the transmitting and receiving sides can be connected in an early time. This can realize early image data transmission and positive image data reception.

Although the present exemplary embodiment has been described heretofore with reference to an image processing apparatus having a fax function, the invention is not limited to this but the invention can also be applied to various kinds of apparatus which are used to transmit and receive image data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image communication apparatus comprising:
a first receiving unit that receives image data through a first communication method;
a second receiving unit that receives image data through one kind or two or more kinds of second communication methods;
a determining unit, when the image communication apparatus receives a call for receiving image data through the first communication method and the first receiving unit cannot receive the image data since the first communication unit is used to receive other image data, that determines one communication method out of the second communication methods according to a standard; and
an informing unit that informs a caller about the determined second communication method and information indicating that the first communication unit cannot receive the image data specified by the call.

2. The image communication apparatus according to claim 1, further comprising:
a responding unit, when after informing by the informing unit, the image communication apparatus receives a new call from the caller through the first communication method or the determined second communication method informed by the informing unit, that responds to the new call through the first communication method or the determined second communication method capable of receiving the image data.

3. An image communication apparatus, comprising:
a first transmitting unit that transmits image data through the first communication method;
a second transmitting unit that transmits image data through one kind or two or more kinds of the second communication methods;
a calling unit, when the image communication apparatus receives a request for transmitting image data through the first communication method, that issues a call to a receiver through the first communication method; and
a transmission executing unit, when, as a result of the call by the calling unit, the image communication apparatus receives from the receiver, information indicating that (i) the receiver cannot receive the image data through the first communication method and (ii) the receiver is to receive the image data through one of the second communication method instead of the first communication method, that executes to transmit the requested image data through said one of the second communication methods.

4. An image communication apparatus, comprising:
a first transmitting unit that transmits image data through the first communication method;
a second transmitting unit that transmits image data through one kind or two or more kinds of the second communication method;
a calling unit, when the image communication apparatus receives a request for transmitting image data through the first communication method, that issues a call to a receiver through the first communication method; and
a transmission executing unit, when, as a result of the call by the calling unit, the image communication apparatus receives from the receiver, information indicating that (i) the receiver cannot receive the image data through the first communication method and (ii) the receiver is to receive the image data through one of the second communication method instead of the first communication method, that issues a new call through both the first communication method and said one of the second communication methods, executes a transmission of the requested image data through one of the first communication method and said one of the second communication methods the line of which is established, and stops the new call through the other.

5. A computer readable medium storing a program causing a computer to execute a process for image communication control, the process comprising:
receiving image data through a first communication method;
receiving image data through one kind or two or more kinds of second communication methods;
determining when receiving a call for receiving image data through the first communication method and receiving the image data is not allowed through the first communication method for receiving other image data, one communication method out of the second communication methods according to a standard; and
informing a caller about the determined second communication method and information indicating that receiving the image data specified by the call through the first communication method is not allowed.

6. The computer readable according to claim 5, the process further comprising:
responding, when after informing the caller, receiving a new call from the caller through the first communication method or the determined second communication method, to the new call through the first communication method or the determined second communication method capable of receiving the image data.

7. A computer readable medium storing a program causing a computer to execute a process for image communication control, the process comprising:
transmitting image data through the first communication method;
transmitting image data through one kind or two or more kinds of the second communication methods;
issuing, when receiving a request for transmitting image data through the first communication method, a call to a receiver through the first communication method; and
executing to transmit the requested image data through said one of the second communication methods when, as a result of issuing the call, receiving from the receiver, information indicating that (i) the receiver cannot receive the image data through the first communication method and (ii) the receiver is to receive the image data through one of the second communication method instead of the first communication method.

8. A computer readable medium storing a program causing a computer to execute a process for image communication control, the process comprising:
transmitting image data through the first communication method;
transmitting image data through one kind or two or more kinds of the second communication method;
issuing, when receiving a request for transmitting image data through the first communication method, a call to a receiver through the first communication method;
issuing, when, as a result of issuing the call, receiving from the receiver, information indicating that (i) the receiver cannot receive the image data through the first communication method and (ii) the receiver is to receive the image data through one of the second communication method instead of the first communication method, a new call through both the first communication method and said one of the second communication methods; and
executing to transmit the requested image data through one of the first communication method and said one of the second communication methods the line of which is established and to stop the new call through the other.
